(19) United States
(12) Patent Application Publication
(10) Pub. No.: US 2022/0086000 A1
(43) Pub. Date: Mar. 17, 2022

(54) CRYPTOGRAPHIC SYSTEMS

(71) Applicant: Soul Machines, Auckland (NZ)

(72) Inventor: Robert Munro, Auckland (NZ)

(21) Appl. No.: 17/436,030

(22) PCT Filed: Mar. 30, 2020
(86) PCT No.: PCT/IB2020/053032

§ 371 Date: Sep. 2, 2021

(30) Foreign Application Priority Data
Mar. 29, 2019 (NZ) 752210

(51) Int. Cl. H04L 9/30; H04L 9/06

(52) U.S. Cl. CPC H04L 9/3073; H04L 9/302; H04L 9/0631

(57) ABSTRACT

The cryptographic system allows a cloud service provider to persist customer data on behalf of an intermediary service provider, but provide end-to-end encryption such that cloud service provider is not able to read the data. A Secrets Vault provides a cryptographically enforced mechanism by which Secrets are protected and only accessible by authorised users or services, and access to Secrets is cryptographically provable. An entity with a valid Credential has an associated Key Pair. The Credential is used to encrypt/wrap the Key Pair (namely the private key of the Key Pair, as by definition public Keys are designed to be publicly accessible). This allows the Key Pair to be stored online, in an encrypted form. Secrets have corresponding Secret Keys which are used to symmetrically encrypt the Secrets. The Secret Keys are then asymmetrically encrypted using public-private key-pairs.

### TECHNICAL FIELD

Embodiments of the invention relate to cryptographic systems.

### BACKGROUND ART

Key management refers to management of cryptographic keys in a cryptographic system, including the generation, exchange, storage, use, destruction and replacement of keys. Traditionally, key management services provide & protect cryptographic keys, such that in the long term, unencrypted keys are stored in a different location from the storage of encrypted data, and users must authenticate themselves with the key management service provider to gain access to the unencrypted key in order to decrypt the data. Key management systems are software applications deployed on servers. Rights to data are generated by the system and enforced through Boolean mechanisms, and access to a key store is unlocked with a username or password which authenticates a person as a user of the system. However, such key management services depend on software-based control (logic/rule-based control), meaning that a flaw in the software may allow unauthorised users to access the keys.

US20180287785 describes a cryptographic system providing a data storage service that uses a key provider to acquire wrap keys (key-encryption key or key-wrapping key that is used by the key-wrap algorithm to encrypt another key) and form a wrap key pool.

### OBJECTS OF THE INVENTION

It is an object of the present invention to improve cryptographic systems or to at least provide the public or industry with a useful choice.

### SUMMARY OF THE INVENTION

A cryptographic system allows a cloud service provider to persist customer data on behalf of an intermediary service provider, but provide end-to-end encryption such that cloud service provider is not able to read the data. A Secrets Vault provides a cryptographically enforced mechanism by which Secrets are protected and only accessible by authorised users or services, and access to Secrets is cryptographically provable. An entity with a valid Credential has an associated Key Pair. The Credential is used to encrypt/wrap the Key Pair (namely the private key of the Key Pair, as by definition public Keys are designed to be publicly accessible). This allows the Key Pair to be stored online, in an encrypted form.

Secrets have corresponding Secret Keys which are used to symmetrically encrypt the Secrets. The Secret Keys are then asymmetrically encrypted using public-private key-pairs.

According to one embodiment: A method of cryptographically securing a Secret for access by an entity, the entity having a Credential and an associated Key Pair, the key pair including a private key and a public key, wherein the private key of the Key Pair is encrypted using the Credential, the method including the steps of: generating a Secret Key; symmetrically encrypting the Secret using the Secret Key; and asymmetrically encrypting the Secret Key using the public key of the Key Pair. Optionally: The private key of the Key Pair is symmetrically encrypted using the Credential. The Secret is encrypted using AES192 or AES256. The Secret Key is encrypted using the RSA algorithm or the Elliptic Curve Digital Signature algorithm. The Secret is a data stream.

According to one embodiment: A method of cryptographically securing at least one Secret for access by an entity, the entity having a Credential and an associated public key, the method including the steps of: for each Secret, generating or receiving a Secret Key Pair including the associated public key and a new private key unique to the Secret; encrypting the private key of the Secret Key Pair using the Credential; and asymmetrically encrypting each Secret using the associated public key of the Secret Key Pair.

According to one embodiment: A method of cryptographically securing at least one Secret for access by an entity, the entity having a Credential and an associated Identity Key Pair, the Identity Key Pair including a public key and a private key, including the steps of: generating or receiving a Secret Key for encrypting the at least one Secret; encrypting the at least one Secret using the Secret Key; asymmetrically encrypting the Secret Key using the Identity Key Pair; and symmetrically encrypting the private key of the Identity Key Pair with the Credential.

According to one embodiment: a system for cryptographically securing Secrets collected by a Data Collector for access by an entity, such that the Secrets are unreadable by the Data Collector, the system including: the entity, wherein the entity is associated with a Credential and an associated public key; a Secret Key Pair generator configured to generate Secret Key Pairs for each Secret, wherein the Secret Key Pairs include the associated public key and a new private key unique to the Secret; and the Data Collector configured to: capture or receive the each Secret, encrypt the private key of each Secret Key Pair using the Credential; and asymmetrically encrypt each Secret using the associated public key of the Secret Key Pair.

A system for cryptographically securing Secrets collected by a Data Collector for access by an entity, such that the Secrets are unreadable by the Data Collector, the system including: the entity, wherein the entity is associated with a Credential and an associated Identity Key Pair; a Secret Key generator configured to generate Secret Keys for each Secret, and the Data Collector configured to: capture or receive each Secret, asymmetrically encrypt each Secret using the Identity Key Pair; and symmetrically encrypt the private key of the Identity Key Pair with the Credential.

### BRIEF DESCRIPTION OF DRAWINGS

FIG. 1 shows a base deployment and usage architecture;

FIG. 2 shows a flow diagram of data obtained from user interaction;

FIG. 3 FIG. 1 shows one example of classification of each part of a data stream that is targeted for capture;

FIG. 4 shows a schematic diagram of the components of the Secrets Vault according to one embodiment;

FIG. 5 shows storage of secrets according to one embodiment;

FIG. 6 shows a cryptographic system according to one embodiment;

FIG. 7 shows a cryptographic system according to another embodiment;

FIG. 8 shows a schematic diagram of an encrypted Secret according to one embodiment; and

FIG. 9 shows a method of storing secrets.

### DISCLOSURE OF INVENTION

### Technical Problem

A technical problem to be solved is allowing protection of user data with a derived key, such that a service provider can hold the data for the user but cannot access it (end-to-end encryption), such that the data can be shared with other users at the behest of the user, while maintaining that end-to-end encryption. Preferably the system would not require any re-encryption of the file data itself, avoiding an expensive operation.

Another challenge is in providing authentication mechanisms which are cryptographically enforced (as opposed to programmatically enforced), decreasing the likelihood of a coding error to result in a third party gaining unauthorized access, and reducing the risk of escalation of privilege attacks. Preferably, a cryptographically enforced system allows new users or service providers to be authorized and de-authorized without affecting other aspects of the system or exposing secrets to third parties.

### Technical Solution

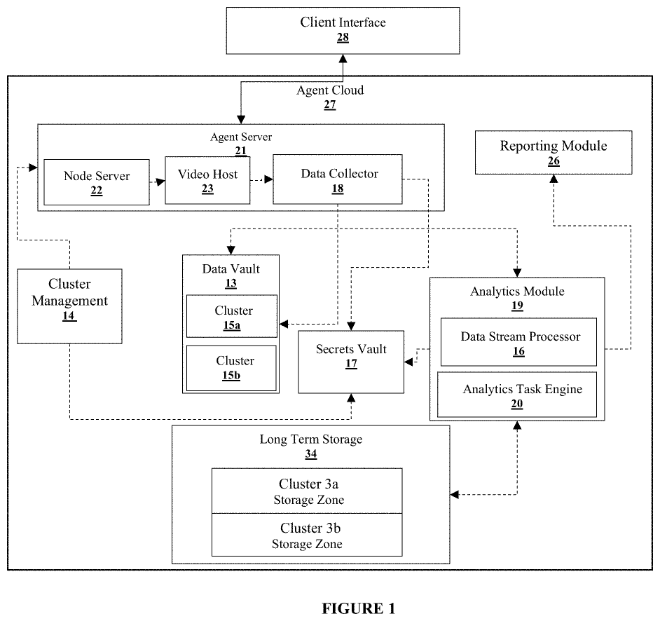

A Secrets Vault provides a cryptographically enforced mechanism by which Secrets are protected and only accessible by authorised users or services. FIG. 1 shows an encryption architecture whereby Secrets are dually-encrypted such that they are only accessible by a user with a valid Credential. An entity with a valid Credential has an associated Key Pair 510. The Credential is used to encrypt/wrap the Key Pair (namely the private key of the Key Pair, as public keys are public). This allows the Key Pair to be stored online, in an encrypted form. Secrets have corresponding Secret Keys which symmetrically encrypt/decrypt the Secrets. The Secret Keys are in turn asymmetrically encrypted using the Key Pair.

In a “multiple secret keys” embodiment, Secrets are encrypted with Secret Keys which are symmetric keys themselves encrypted with Identity Key Pairs associated with authorized user Credentials. In “multiple secret keys” embodiments, Credentials are 1:1 with Identity Key Pairs. Secret Keys are generated regularly, on demand, and double-encrypt all sensitive information, such as sessions or configuration information. Providing valid Credentials allows decryption of Identity Key Pairs, which in turn allows decryption of all Secret Keys stored under those Identity Key Pairs which can be used to decrypt their respective Secrets. The Secret Key is asymmetrically encrypted using the unencrypted private key of the Identity Key Pair. FIG. 1 shows a schematic diagram of Secrets stored according to a “multiple secret keys” embodiment. Four entities, which are Service Providers A, B, C and D each have respective Credentials, and respective Identity Key Pairs. Service Provider B has access to Secret X via a copy of Secret Key X which is encrypted by the Service Provider B's public Key B. Service Provider A has access to two Secrets, Secret X and Secret Y. Service Provider C has access only to Secret Y, and Service Provider D has access to Secret X and Secret Y. For each Secret, multiple Secret Keys are stored; one for each entity with access. Three copies of Secret Key X exist, because Service Provider A, B, and D each have an associated Secret Key. Similarly, three copies of Secret Key Y exist, because Service providers A, C and D each have a copy.

In a “multiple key-pair” embodiment, a Credential is associated with a public key of an authorised entity. For each new Secret to be accessible by the entity, a new Secret Key Pair is created using the public key and a private key unique to the Secret and the entity. The Secret is asymmetrically encrypted using the private key, and the private key of the Identity Key Pair is encrypted using the Credential. So, instead of using a new Secret Key for each authorized entity, a single Secret Key is used to create multiple Secret Key Pairs associated with the Credential. FIG. 1 shows a schematic diagram of Secrets stored according to a “multiple key-pair” embodiment. Each Secret has one corresponding Secret Key, which may be asymmetrically encrypted multiple times to create a new Secret Key Pair for each entity with access to the secret. Service provider B has access to one secret: Secret X. Service Provider A has access to three Secrets: X, Y and Z. Secret Y is accessible by three entities: Service Provider A, Service provider C and Service Provider D.

### Elements of the Secrets Vault

A Secrets Vault 17 includes Identity Key Pairs or Secret Key Pairs, Credentials, Secret Keys and a key and identity database (Secrets Key DB).

### Secret

The system may be used to protect any Secrets. A Secret is any data to which access is controlled and may include Sensitive Configuration and/or Credential Data. In one embodiment, Secrets are sensitive data streams. Configuration and/or credential data such as external service credentials or other application settings that might be considered sensitive can similarly be encrypted as Secrets and stored in the Secrets Vault to keep sensitive data secure and in an authenticated state. Sensitive configuration and credential data may be stored as a binary or text chunk in the Secrets Vault along with a hmac (e.g. HMAC256) which is used to verify the integrity of the data to the data owner (the authorised assessor/creator of the secret data)

### Credential

The Credential is a key, or a key generated via a password using a standard password-based protection mechanism. For example, it may be generated using PBKDF2. The Credential is used to encrypt and protect the Identity Key Pair private key.

### Identity Key Pair

The Identity Key Pair includes a public key certificate unique to the entity/user with an associated Credential. For example, it may be implemented using the RSA, or the Elliptic Curve Digital Signature Algorithm. The public key portion of the Identity Key Pair is used for Secret encryption and validation purposes. In cryptographical systems as described herein, Identity Key Pairs are 1:1 with Credentials. A private key portion of an Identity Key Pair is encrypted using the Credential and is used to decrypt protected Secret Keys.

### Secret Key Pair

Similarly, the Secret Key Pair also includes a public key certificate unique to the entity/user with an associated Credential. For example, it may be implemented using the RSA, or the Elliptic Curve Digital Signature Algorithm. The public key portion of the Secret Key Pair is used for Secret encryption and validation purposes. In cryptographical systems as described herein, a plurality of Secret Key Pairs are created for each Secret to be secured under a particular Credential. The private key portions of each Secret Key Pair are protected using the Credential and are used to decrypt protected Secret Keys or Secrets.

### Secret Key

The Secret Key (which may be a session protection key) may be any suitable symmetric encryption key. For example, a standard AES192 or AES256 encryption key may be used. These Secret Keys are unique to each session and Service Provider. Secret Keys are never stored or transmitted unencrypted. When stored in the Secrets Key DB, the Identity Key Pair private key is used to encrypt the Secret Key. Each block of sensitive data in a cloud service may be encrypted with an Secret Key.

A Secret Key may be used to protect data itself protected or encrypted with a user credential e.g. in the form of the Identity Key Pair private key. User credential could be private/public or user's password. In other words, the Secret Key is wrapped in a manner which requires a user credential. The wrapper is cryptographically enforced.

### Secrets Key DB

Secret Keys are always stored in an encrypted form. The Secrets Key DB is a key and identity database. In one embodiment, this may be a network isolated (clustered) database that stores the contents of Service Provider encrypted session keys (Secret Keys). This database is only accessible via approved and access-controlled mechanisms.

### Secrets Vault

FIG. 5 shows the basic mechanism of the Secrets Vault according to one embodiment. A stores three credentials, including a Master Credential 502, a Service Provider Credential 504 and a service Credential 506.

The Master Credential 502 is used to encrypt Identity Key Pair 510, creating an encrypted Private Key 552. The Master Credential 502 is also used to encrypt Protection Identity Key Pair 512, creating an encrypted Private Key 555. The Service Provider Credential 504 is also used to encrypt Identity Key Pair 510, and a second encrypted Private Key 553 of the Identity Key Pair 512 is created and stored with the Identity Key Pair 512, associated with the Service Provider Credential 504. The service Credential 506 is used only to encrypt Identity Key Pair 514, creating a third copy of a private key for Identity Key Pair 514 (in addition to private keys 558 and 559 created by a Master Credential 502 and a Service Provider Credential 504 respectively).

### Authentication Code:

A hash-based message authentication code may be generated when a Secret (e.g. session data) is stored, to allow for cryptographically secure data integrity checks.

### Access Control & Auditing

An access control mechanism may be used to control any access to Event Data Stream data, regardless of the categorization of data, as well as to Secret Keys. This mechanism ensures that a basic identity check has been performed on the user requesting access to the data and that only data the user is authorized to access is available. Access is tied to a user's role and identity. Users have a set of permissions which governs which part of the Event Data Stream can be accessed and what can be done with the data. Additionally, use of Identity Key Pair ensures that a Service Provider's data can only be accessed by users with permission to access the Service Provider's Identity Key Pair.

All requests of access, regardless of whether they are successful, may result in an audit event being created in a temper resistant audit log. The log allows all data request to be audited and verified, providing a history trace of data streams from creation through to eradication.

### Process

### Encrypting a Secret

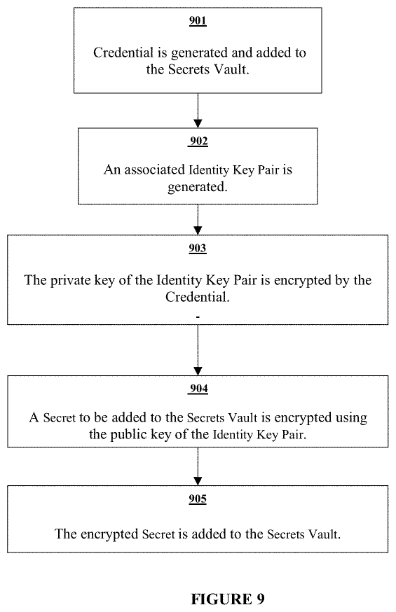

FIG. 9 shows a method of encrypting a Secret, and FIG. 5 shows a schematic diagram of a plurality of Secrets stored as per the method shown in FIG. 9.

At step 901, a Credential is generated and added to the Secrets Vault. The Credential may be a private public key pair, a password, or any other suitable credential.

At step 902, an associated PPKP (private public key pair) is generated. The PPKP (e.g. Identity Key Pair) may be generated at the same time as the Credential is added to the Secrets Vault. The Identity Key Pair may be a given a name if not supplied.

At step 903, the PPKP is encrypted by the Credential. If the credential was a password then a symmetric key is derived from the password (via an algorithm such as PBKDF2). If the Credential is a public/private key (e.g. in a PEM file) the public key of the Credential is used to encrypt/wrap the private key of the Identity Key Pair.

For each new Credential authorised to access the new PPKP, an encryption process as described in step 903 is repeated using the new Credential for encryption, and the encrypted a copy of the private key of the PPKP is stored.

At step 904, a Secret to be added to the Secrets Vault is encrypted using a Secret Key. The Secret Key is created using a specified PPKP (which may be specified using the Credential and the name of the PPKP). The PPKP is used (i.e. the public key portion of the PPKP) to protect the Secret which then requires access to the private key portion of the PPKP to decrypt the Secret.

At step 905, the encrypted Secret is added to the Secrets Vault.

### Accessing a Secret

To access a Secret a valid Credential is needed to access the Identity Key Pair or the Secret Key Pair for the Secret.

In the “multiple secret keys” embodiment, if the Credential is valid the Identity Key Pair can be unwrapped/decrypted and the private key of the Identity Key Pair may be accessed and used to decrypt the Secret Key. When a Secret being stored is a chunk of data (rather than a session key), a new symmetric key is generated when the data is added, and used to decrypt the secret data.

In the “multiple keypair” embodiment, if the Credential is valid the Secret Key Pair can be unwrapped/decrypted and the private key of the Identity Key Pair may be accessed and used to decrypt the Secret.

Key pairs are used as the secret encryption key source as this allows for read and write authorisation to be separately controlled. Allowing one credential write only access (via the public key) and another credential read and write access (using both keys).

### Access Control

The creator of a Secret is the initial authorizer, and authorizes read access to the Secret. The creator wraps the Secret for each entity authorized to access the Secret.

### Adding a New User

A new Credential is authorized access to secrets kept by a Identity Key Pair by using a pre-authorized Credential to decrypt its copy of the private key of the Identity Key Pair, providing it to the new Credential, which re-encrypts its own copy of the private key of the Identity Key Pair using its own Credential.

### Revoking User Access

In the “multiple secret keys” embodiment, access to a Secret can be revoked by removing the applicable Secret Key from their keychain. In the “multiple keypair” embodiment, access to a Secret can be revoked by removing the applicable Secret Key Pair. Only access to the entity's keychain is required. A revocation list may be kept, for example, when a user logs into the cryptographic system their keychain may be grabbed and the “key” to access the secret may be removed from their keychain.

### Read and Write Access

As Identity Key Pairs are used as the source of Secret Keys, this allows read and write authorization to be separately controlled, by allowing one Credential write only access (via the public key), and another Credential read-write access (using both keys).

User A, using User B's credential can load a public key from User B's Identity Key Pair to encrypt a Secret using a Secret Key created using User B's Public Key of User B's Identity Key Pair. A record is created for the Secret. Once the Secret is encrypted, User A can no longer access the data, unless User A has a Secret Key duplicated and wrapped with User A's own public key from User A's Identity Key Pair. To read the data, User B decrypts their private key, so can unwrap the Secret Key using their Private key, and use the unwrapped Secret Key to unencrypt the Secret. Thus any user with a Credential is able to insert data and write Secrets. However, read access is cryptographically enforced.

### Storing New Secrets

Services or entities which collect data can store data that they are not allowed to access. For example, a Data Collector can encrypt data that an analytics service can read and use for analytics purposes. Authorization of the Analytics modules is cryptographically enforced, and the Data Collector does not have access to the data once it has been stored.

### Overwriting Secrets

The overwriting of Secrets may be protected against using hashes or signatures.

### Credential Use and Management

Any access to a Secrets Vault requires a valid Credential. If no valid Credential is presented then no operations on the Secrets Vault are permissible. The Credential specified also controls which secrets within the vault are accessible by nature of the key wrapping mechanism.

Credentials can be either a password, from which a symmetric key is derived or a PEM file which contains both a public and private key. As PEM files are usually protected with a password (or should be) this would also be required when a PEM file is used as a Credential.

Credentials can have one of two authorisations writeonly or readwrite. Write only authorised Credential may only add secrets and not read them. When added, a new Credential has created with validation mechanism in the form of a digital signature, this allows the detection of Credentials that have been illicitly replaced.

In one embodiment, at least two Credentials are automatically added when a new Secrets Vault is created, one of which is required to add new Credentials.
Master Credential: This may be a PEM only credential with readwrite access to every key-pair in the vault. This may ensure a forgotten or revoked password does not result in secrets becoming inaccessible.
Service Provider Credential: This is the customer protection identifier (CPI) this Credential likewise has mechanism full access to every PPKP but it can be either a PEM based Credential or a password based Credential.

Validation requires access to the master Credential private key or the CPI private key. In the case of a Master and Service Provider Credential they act as each other alternate validation mechanism, as the Service Provider Credential validates the master. Key validation is a performance and data validation mechanism only, not a security one. Replacing a Credential by directly overwriting the data will not help as the PPKP wrapping function will fail when used with the replacement Credential.

Embodiments described herein allow entities to change their passwords in a simple manner. For example, a user has secrets stored under using a Credential which is a password “password1”. An expensive hash function such as pkb22 may process the password to create a hashed password. The hashed password is in turn used as an encryption key to store the Service Provider's encryption key which can be used to decrypt the real key to the user's keychain (their Identity Key Pair). If the user wishes to change their password to “password2”, the Service Provider only needs to re-encrypt their own key to the user's keychain (their Identity Key Pair).

### Implementation According to One Embodiment

In one embodiment, the cryptographic system described herein is used to protect data captured during a session of an end-user interacting with a computer system. The user may be interacting with an Agent, which may be an embodied Agent interacting with the user in real time through verbal and non-verbal communication via a computer microphone and camera. An Agent provider (Master) may provide the Agent on behalf of a Service Provider. In a further embodiment, end users may also have a Credential to the cryptographic system and Secrets corresponding to their personal data may be only readable by the users and selectively shareable with the Service Provider/s and/or the Agent provider.

FIG. 1 shows a base deployment and usage architecture. A Data Collector 18 collects and processes raw session event data. A Data Stream Processor 16, processes session data, providing normalised, time series data streams for the analytics tasks. The Secrets Vault 17 collects and protects various session encryption keys created during a data collection session.

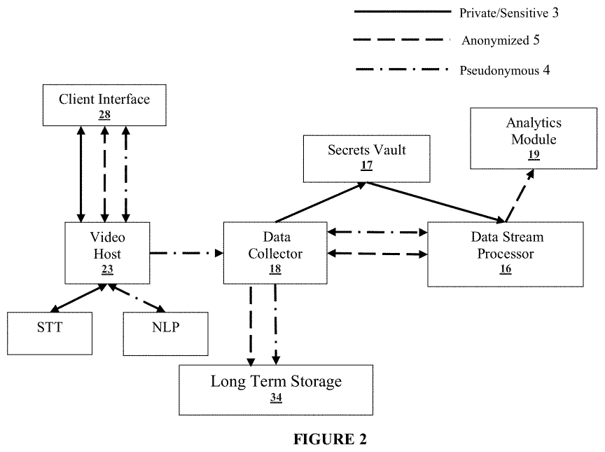

FIG. 2 outlines the basic flow of data from user interaction. All data that flows through the Agent Server 27 may use secure, encrypted network connections, such as TLS 1.2 or better (HTTPS). The data flows are represented by coded arrows that represent the nature of the data and the directionality of the data flow.

### Data Collector

The Data Collector 18 accepts an incoming socket connection from the Video Host 23 (Video Host process) and reads all session event messages as they flow from the server. The Data Collector 18 has a Credential and is thus able to write and store Secrets. However the Data Collector 18 does not create any copies of Secret Keys with its own credential; and has writeonly access to Secrets Vaults and this property may be cryptographically provable by the absence of any encrypted Secret Keys associated with the Data Collector's 18 credential.

The Data Collector 18 classifies data that is collected. Pseudonymous or Private/Sensitive elements are encrypted with a symmetric session encryption key (a Secret Key) which is generated at session initialization. The Secret Key is then encrypted using the public key of the Identity Key Pair of any services requiring read access to the data. Thus the Data Collector 18 authorises services or users to access the Secret but does not authorise itself to read the Secret. The Secret Key is stored in encrypted form in the Secrets Vault. As data elements are encrypted the raw data is replaced in the event stream with a reference to the encrypted data which is stored in an alternate data stream. The Secret Key is never stored in disk in unencrypted form. The Secret Key is created in memory, transferred only over an encrypted communication channel (such as HTTPS), and stored in the Secrets Vault in an encrypted form. The classified and protected data elements are then written out to a data vault instance (such as a Cassandra cluster node) into a raw session table. An internet facing REST interface may be built onto the Data Collector to manage session data collection for suitable scenarios, for example, Agent interaction is on a mobile device or non-a cloud hosted kiosk.

### Data Stream Processor

The Data Stream Processor 16 provides the Analytics Module 19 with a normalised, time series view of the raw session data to allow for easier and more consistent processing. The Data Stream Processor 16 may be run on demand to provide access to session data.

The service will read the raw session data provided by the Data Collector 18 and provide a Spark dataset that can be used during processing. The provided data set will include both anonymous and decrypted (sensitive) data in a normalised view. The dataset can persist in memory (or generated on demand) for various spark task to work off. The data is not preserved beyond the lifetime of the processing tasks as the sensitive data is never to be cached or written out to any form of long-term storage. The Data Stream Processor 16 may be implemented Java to facilitate integration with JVM based services such as Cassandra and Spark.

### Data Vault

A Data Vault provides the storage and retrieval mechanisms for long term structured data or times-series based data. The Data Vault supports safe and resilient storage of both sensitive and generalised or anonymous data. Any suitable server and corresponding architecture may be used to implement the Data Vault. One example is the Cassandra NoSQL server. The Data Vault may be deployed in a clustered server model with a plurality of clusters being initially deployed—for example, one cluster may be in the EU to isolate EU data for GDPR compliance, and another more general cluster may support storage needs of other geographic locations.

### Provisioning

When a new Service Provider is provisioned on an Agent Cloud an initial ‘provisioning’ step may generate a Identity Key Pair and an associated Credential before any session data streams are protectable. The Credentials and Identity Key Pairs which are generated are then stored securely in a Secrets Key DB.

Session data streams are protected via the generation, use and storage of Secret Keys. A new Secret Key is generated on demand for each session and is securely stored in the Secrets Vault immediately after generation. Sensitive data streams can optionally use an authenticated encryption mode (like AES GCM) or use an ‘authentication code’ stored with the secured data stream as a mechanism to ensure the stored data is unchanged from when it was originally collected. A session data stream may comprise different classifications of data. Each part of a data stream that is targeted for capture may be classified accordingly. One example of possible classifications of data include Private/Sensitive data, Pseudonymous data and Anonymized data.

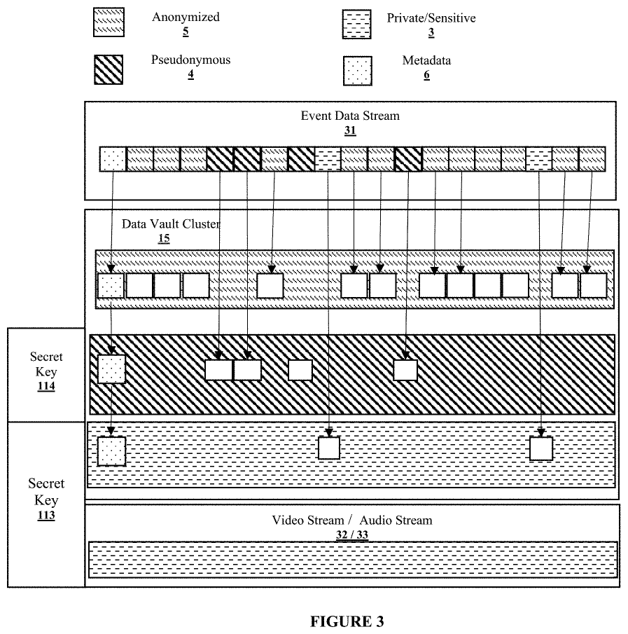

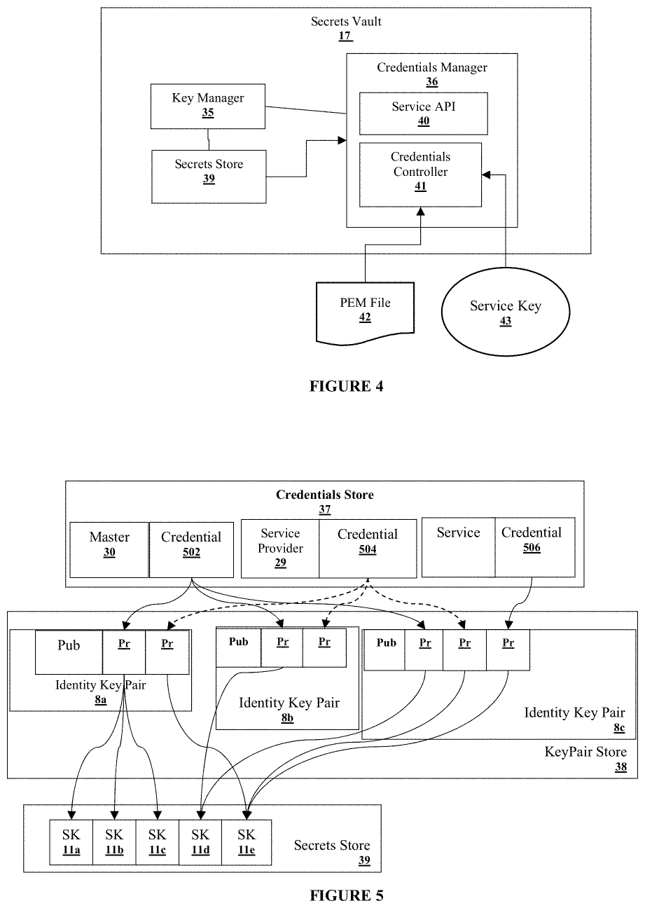

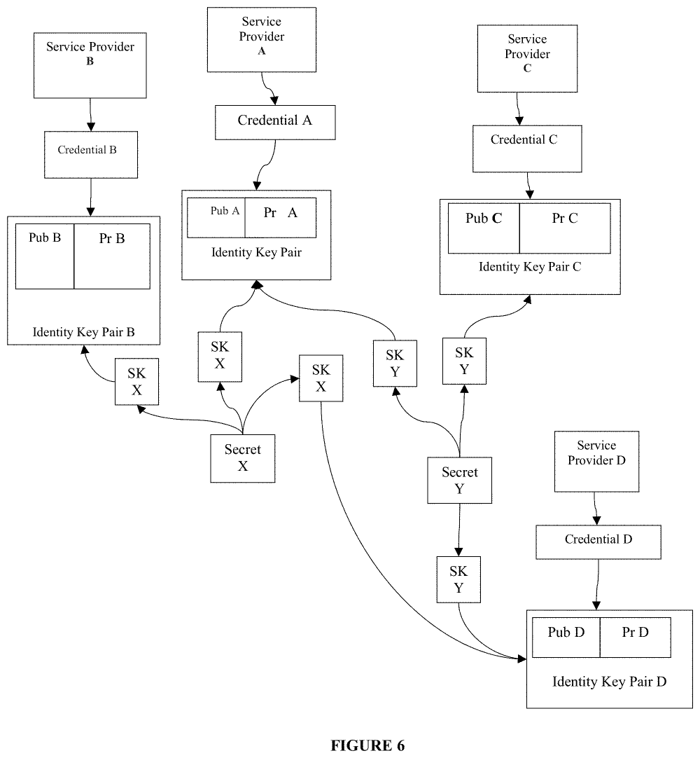

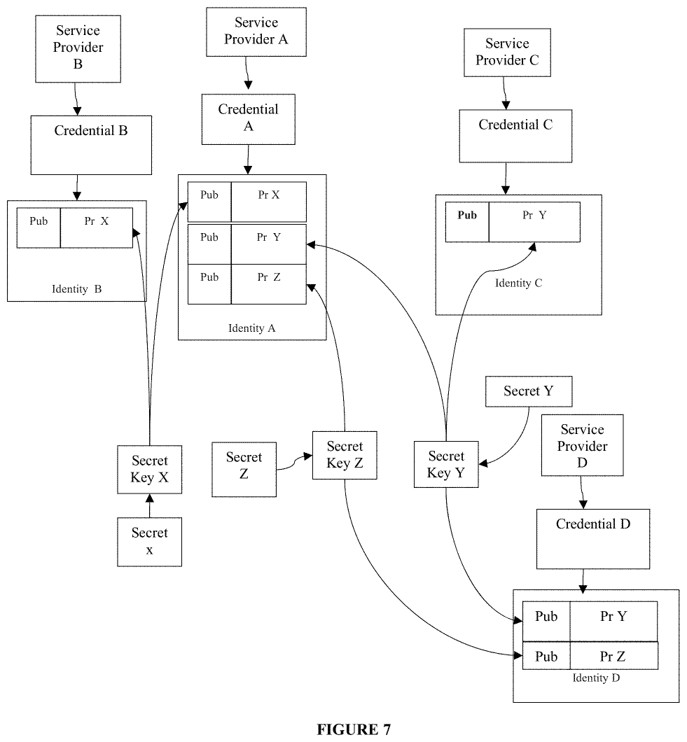

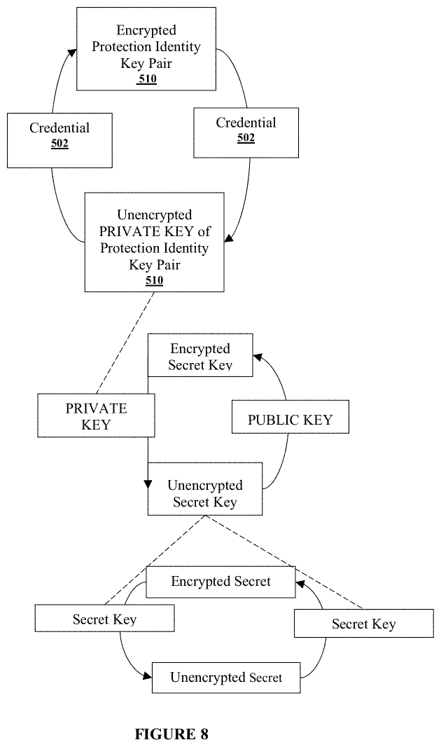

FIG. 3 shows one example of classification of each part of a data stream that is targeted for capture. An Event Data Stream 31 man include a stream of data. Each part of the Event Data Stream 31 is categorized as Private/Sensitive data 3, Pseudonymous data 4 or Anonymized data 5. Different classifications of data are protected independently, using independent Secret Keys. For example, parts of the Event Data Stream 31 which constitute Private/Sensitive data 3 are encrypted using Secret Key 113, and parts of the Event Data Stream 31 which constitute Pseudonymous data 4 are encrypted using Secret Key 114. Metadata 6 corresponding to the Event Data Stream 31 may also be stored along with the data itself, and may also be encrypted. Optionally, a Video Stream 32 and/or Audio Stream 33 may also be stored under the Secret Key 113. Anonymized data 5 may be unencrypted.

### Secrets Vault Service

In one embodiment, the Secrets Vault service may run as native Linux process, and provide a REST interface and an additional cli based command interface for interacting with the database. The CLI interface simply presents a command line alternative to the same features provided by the REST interface. All access, either CLI or REST based (HTTPS only) is authenticated using the built in credentials mechanism (see Credential Use and Management). The following set of operations may be provided:
Add/Remove Credential—requires the use of either the Master Credential or the Service Provider Credential to complete
Authorise Credential-Adds the Credential to an authorise list for a Secret. Requires the use of either the master Credential or the customer Credential to complete
View Credential—requires any Credential valid in the Secrets Vault.
View/Remove Identity Key Pairs-View/Remove required an authorised Credential
Add Identity Key Pairs—requires any Credential valid in the Secrets Vault.
View/Add/Remove Secret—requires the correct Credential for the Secret

### Service API

In one embodiment, a service REST API may provide endpoints for the primary functions of the Secrets Vault. All REST API methods may be secured using a JWT token that the client will need to generate, and the server will verify. An API such as the following may be implemented:

| /vault/{vault name}/{entity type}/{action} | |
|---|---|
| {vault name} | name of a vault db file |
| {entity type} | Credential, Identity Key Pair, or Secret |
| {action} | add, remove, get |

With corresponding REST URL examples as follows:

/vault/soulmachines1/credential/add
/vault/rbs-qa/secret/add
/vault/autodesk-prod/secret/get

FIG. 1 shows a schematic diagram of the components of the Secrets Vault 17.

### Database Management & Schema Design

Any suitable backend storage mechanism may be used for the Secrets Vault, e.g. sqlite3 or Cassandra. The Secrets Vault design may allow for a single vault db file and multiple secrets db files. This provision facilitates the large volume of session keys that may be generated by allowing a new secrets db to be created at specific periods of time (e.g. monthly) preserving measurable end predictable performance (for I/O) and easier data management (backup). A distributed file system mechanism may provide db distribution, replication and snapshotting. Individual db files may be stored in a hierarchical directory structure to facilitate ease of management.

```
CredentialsDB Schema
CREATE TABLE IF NOT EXISTS Credentials (
ID INTEGER PRIMARY KEY,
  Owner TEXT NOT NULL,
  Name TEXT NOT NULL,
  Type TEXT,
  ValidationData BLOB,
  Signature BLOB,
  CreationDate DATETIME DEFAULT(DATETIME(′now′))
);
CREATE INDEX IF NOT EXISTS Credentials_Owner ON Credentials
(Owner, Name);
CREATE TABLE IF NOT EXISTS KeyData (
  ID INTEGER PRIMARY KEY,
  CredentialID INTEGER NOT NULL,
  Creator TEXT,
  Name TEXT,
  Algorithm TEXT,
  AuthType INTEGER,
  PublicKey BLOB,
  WrappedPrivateKey BLOB,
  KeyWrapper BLOB,
  ValidationData BLOB,
  CreationDate DATETIME DEFAULT(DATETIME(′now′))
);
CREATE INDEX IF NOT EXISTS KeyData_Credential ON KeyData
(CredentialID, Name);
CREATE INDEX IF NOT EXISTS KeyData_Name ON KeyData (Name);
SecretDB Schema
CREATE TABLE IF NOT EXISTS Secrets (
  ID INTEGER PRIMARY KEY,
  KeyID INTEGER NOT NULL,
  Name TEXT,
  Creator TEXT,
  DataType TEXT,
  SecretData BLOB,
  ValidationData BLOB,
  CreationDate NUMERIC DEFAULT(DATETIME(′now′))
);
CREATE INDEX IF NOT EXISTS Secret_KeyData ON Secrets (KeyID,
ID);
CREATE INDEX IF NOT EXISTS Secret_Name ON Secrets (Name);
CREATE TABLE IF NOT EXISTS SecretsKeyData (
  ID INTEGER PRIMARY KEY,
  KeyID INTEGER NOT NULL,
  SecretID INTEGER NOT NULL,
  KeyType TEXT,
  KeyData BLOB,
  CreationDate NUMERIC DEFAULT(DATETIME(′now′))
);
CREATE INDEX IF NOT EXISTS Secret_Id ON SecretsKeyData
(SecretID);
```

### Threat Models

Security considerations for the design of the secrets vault and securing the data contained within the various tables data repositories include mitigations for possible threats as follows:
Threat: An attacker gains access to the backend storage mechanism using the remote REST interface.→Mitigation: Secrets servers are not accessible to the public internet. Secrets servers are deployed behind private VPC's.→Mitigation: Access to the REST interface requires authentication. Authentication is implemented using the credentials model specified, with all REST users requiring a valid credential for perform any action.
Threat: Attacker adds a new credential to a backend storage mechanism→Mitigation: New credentials can only be added by the master credential or customer CPI
Threat: Attacker overrides master or CPI credential→Mitigation: During creation the master and CPI credentials are created and added together, during that process each credential has a signature generated to confirm the integrity of the credential.→Mitigation: Even if the Master and CPI keys are able to be overridden, all existing data is still secure are the existing PPKP keys will not be accessible due to differences in the new credentials.
Threat: Attacker attempts to brute force a session key to gain access to the raw data.→Mitigation: Only secure encryption algorithms are used (AES256 or better)
Threat: Attacker compromises a credential gaining access to a set of the secured key data.→Mitigation: This is difficult to detect (other than audit). However if detected the credential can be replaced using the Master credential, and also remove the old wrapped PPKP.

### Advantageous Effects

Each Service Provider (which may be a customer of Master) is assigned a unique protection identity (Identity Key Pair).
Each Service Provider has the ability to assign a protection mechanism/key (Credential) to their unique protection identity (Identity Key Pair), making it accessible only to them (optionally, even to the exclusion of the Master).
Each authorised user has its own set of access rights and Credentials to Secrets. In other words, new encrypted private keys of Identity Key Pair are stored for each user with Credentials to access the Identity Key Pair.
The Identity Key Pair is used to secure all keys used for protecting individual session data streams.
Each session data stream can be assigned a unique Secret Key for the protection of sensitive data.
Different sources or classifications of data may be classified and protected with independent Secret Keys.
Secret Keys used in protecting sensitive session data are not accessible to non-authorised individuals.
The protection process protects an individual (identified) user's data independently from other data streams of a customer.
All session and customer identities and keys may be protected and stored in a secure, centralised database (Secrets Vault) that may be protected by access control mechanism as an additional protection step.
Each authorized user has their own/independent set of credentials and access rights to material
Integrity checks can be performed on sensitive data to ensure that no tampering has occurred.
Encryption is cryptographically enforced, rather than depending on software logic roles/algorithms/rules-based control.
As only the private keys of Identity Key Pairs are wrapped, the insertion and encryption of new Secrets is possible without Credentials, however the subsequent decryption of the Secrets is only possible with someone with Credentials associated with corresponding Identity Key Pairs.
The creation and revocation of access is facilitated by the notion of unique Credentials, without requiring any other aspects of the system to be changed. Once a user's Identity Key Pair is removed the user can no longer access any Secrets.
The separation of Credentials and Identity Key Pair security protects against unauthorized access because access is granted cryptographically, prohibiting backdoor access.

### Interpretation

The methods and systems described may be utilised on any suitable electronic computing system. According to the embodiments described below, an electronic computing system utilises the methodology of the invention using various modules and engines.

The electronic computing system may include at least one processor, one or more memory devices or an interface for connection to one or more memory devices, input and output interfaces for connection to external devices in order to enable the system to receive and operate upon instructions from one or more users or external systems, a data bus for internal and external communications between the various components, and a suitable power supply. Further, the electronic computing system may include one or more communication devices (wired or wireless) for communicating with external and internal devices, and one or more input/output devices, such as a display, pointing device, keyboard or printing device.

The processor is arranged to perform the steps of a program stored as program instructions within the memory device. The program instructions enable the various methods of performing the invention as described herein to be performed. The program instructions, may be developed or implemented using any suitable software programming language and toolkit, such as, for example, a C-based language and compiler. Further, the program instructions may be stored in any suitable manner such that they can be transferred to the memory device or read by the processor, such as, for example, being stored on a computer readable medium. The computer readable medium may be any suitable medium for tangibly storing the program instructions, such as, for example, solid state memory, magnetic tape, a compact disc (CD-ROM or CD-R/W), memory card, flash memory, optical disc, magnetic disc or any other suitable computer readable medium.

The electronic computing system is arranged to be in communication with data storage systems or devices (for example, external data storage systems or devices) in order to retrieve the relevant data.

It will be understood that the system herein described includes one or more elements that are arranged to perform the various functions and methods as described herein. The embodiments herein described are aimed at providing the reader with examples of how various modules and/or engines that make up the elements of the system may be interconnected to enable the functions to be implemented. Further, the embodiments of the description explain, in system related detail, how the steps of the herein described method may be performed. The conceptual diagrams are provided to indicate to the reader how the various data elements are processed at different stages by the various different modules and/or engines.

It will be understood that the arrangement and construction of the modules or engines may be adapted accordingly depending on system and user requirements so that various functions may be performed by different modules or engines to those described herein, and that certain modules or engines may be combined into single modules or engines.

It will be understood that the modules and/or engines described may be implemented and provided with instructions using any suitable form of technology. For example, the modules or engines may be implemented or created using any suitable software code written in any suitable language, where the code is then compiled to produce an executable program that may be run on any suitable computing system. Alternatively, or in conjunction with the executable program, the modules or engines may be implemented using, any suitable mixture of hardware, firmware and software. For example, portions of the modules may be implemented using an application specific integrated circuit (ASIC), a system-on-a-chip (SoC), field programmable gate arrays (FPGA) or any other suitable adaptable or programmable processing device.

The methods described herein may be implemented using a general-purpose computing system specifically programmed to perform the described steps. Alternatively, the methods described herein may be implemented using a specific electronic computer system such as a data sorting and visualisation computer, a database query computer, a graphical analysis computer, a data analysis computer, a manufacturing data analysis computer, a business intelligence computer, an artificial intelligence computer system etc., where the computer has been specifically adapted to perform the described steps on specific data captured from an environment associated with a particular field.

REFERENCE SIGNS LIST

| | |
|---|---|
| 1 | Agent |
| 2 | Secret |
| 3 | Private/Sensitive |
| 4 | Pseudonymous |
| 5 | Anonymized |
| 6 | Metadata |
| 7 | PPKP |
| 8 | Identity Key Pair |
| 9 | Secret Key Pair |
| 10 | Credential |
| 11 | Secret Key |
| 12 | Secrets Key DB |
| 13 | Data Vault |
| 14 | Cluster Management |
| 15 | Cluster |
| 16 | Data Stream Processor |
| 17 | Secrets Vault |
| 18 | Data Collector |
| 19 | Analytics Module |
| 20 | Analytics Task Engine |
| 21 | Agent Server |
| 22 | Node Server |
| 23 | Video Host |
| 24 | Storage Zone |
| 25 | Distributed File Storage |
| 26 | Reporting Module |
| 27 | Agent Cloud |
| 28 | Client Interface |
| 29 | Service Provider |
| 30 | Master |
| 31 | Event Data Stream |
| 32 | Video Stream |
| 33 | Audio Stream |
| 34 | Long Term Storage |
| 35 | Key Manager |
| 36 | Credentials Manager |
| 37 | Credentials Store |
| 38 | KeyPair Store |
| 39 | Secrets Store |
| 40 | Service API |
| 41 | Credentials Controller |
| 42 | PEM File |
| 43 | Service Key |

1. A method of cryptographically securing a Secret comprising data captured during a session of an end-user interacting with a computer system in real time for access by an entity, the entity having a Credential and an associated Key Pair, the key pair including a private key and a public key, wherein the private key of the Key Pair is encrypted using the Credential, the method including the steps of:
generating a Secret Key;
symmetrically encrypting the Secret using the Secret Key; and
asymmetrically encrypting the Secret Key using the public key of the Key Pair; and
wherein the private key of the Key Pair is symmetrically encrypted.

2. (canceled)

3. The method of claim 1 wherein the Secret is encrypted using AES192 or AES256.

4. The method of claim 3 wherein the Secret Key is encrypted using the RSA algorithm or the Elliptic Curve Digital Signature algorithm.

5. The method of claim 4 wherein the Secret is a data stream.

6. A method of cryptographically securing at least one Secret for access by an entity, the entity having a Credential and an associated public key, the method including the steps of:
for each Secret, generating or receiving a Secret Key Pair including the associated public key and a new private key unique to the Secret;
encrypting the private key of the Secret Key Pair using the Credential; and
asymmetrically encrypting each Secret using the associated public key of the Secret Key Pair.

7. A method of cryptographically securing at least one Secret for access by an entity, the entity having a Credential and an associated Identity Key Pair, the Identity Key Pair including a public key and a private key, including the steps of:
generating or receiving a Secret Key for encrypting the at least one Secret;
encrypting the at least one Secret using the Secret Key;
asymmetrically encrypting the Secret Key using the Identity Key Pair; and
symmetrically encrypting the private key of the Identity Key Pari with the Credential.

8. A method comprising decrypting a Secret encrypted by the method of claim 1.

9. A system for cryptographically securing Secrets collected by a Data Collector for access by an entity, such that the Secrets are unreadable by the Data Collector, the system including:
the entity, wherein the entity is associated with a Credential and an associated public key;
a Secret Key Pair generator configured to generate Secret Key Pairs for each Secret, wherein the Secret Key Pairs include the associated public key and a new private key unique to the Secret; and
the Data Collector configured to:
capture or receive each Secret,
encrypt the private key of each Secret Key Pair using the Credential; and
asymmetrically encrypt each Secret using the associated public key of the Secret Key Pair.

10. A system for cryptographically securing Secrets collected by a Data Collector for access by an entity, such that the Secrets are unreadable by the Data Collector, the system including:
the entity, wherein the entity is associated with a Credential and an associated Identity Key Pair;
a Secret Key generator configured to generate Secret Keys for each Secret, and
the Data Collector configured to:
capture or receive each Secret,
asymmetrically encrypt each Secret using the Identity Key Pair; and
symmetrically encrypt the private key of the Identity Key Pair with the Credential.
